(19) United States
(12) Patent Application Publication
(10) Pub. No.: US 2015/0358387 A1
(43) Pub. Date: Dec. 10, 2015

(54) SMART DEVICE VEHICLE INTEGRATION

(71) Applicant: Myine Electronics, Inc., Ferndale, MI (US)

(72) Inventors: Scott SMEREKA, Warren, MI (US); Jacob R. SIGAL, Ferndale, MI (US); Joey Ray GROVER, Madison Heights, MI (US)

(21) Appl. No.: 14/300,978

(22) Filed: Jun. 10, 2014

(51) Int. Cl. H04L 29/08; G06F 3/0482; G06F 3/0484

(52) U.S. Cl. CPC H04L 67/025; H04L 67/125; G06F 3/04842; G06F 3/0482

(57) ABSTRACT

A vehicle computing system (VCS) may include a smart device interface configured to provide VCS applications with access to remote smart device features; a scripting application configured to utilize the smart device interface to execute scripting settings to automate the remote smart device features; and a user interface of the scripting application configured to facilitate editing of scripting settings when driver workload, as determined by the VCS, is below a predetermined threshold value. A configuration server may be configured to receive, via a user interface provided by the server, an action to be performed by a vehicle and a trigger specifying a condition upon which the action should be performed by the vehicle, generate a scripting setting including the action and the trigger, and provide the scripting setting to a vehicle for execution.

### TECHNICAL FIELD

This disclosure generally relates to vehicle integration with smart devices.

### BACKGROUND

Smart devices include various types of network-connected devices that perform useful functions and expose device functionality over a network connection. As some examples, smart devices may include networked thermostat controls, remote door locks and openers, remote light controls, security devices such as window sensors, flood sensors, and webcams, and even media systems such as remote controls for music playback.

### SUMMARY

In a first illustrative embodiment, a system includes a vehicle computing system (VCS) including a smart device interface configured to provide VCS applications with access to remote smart device features, a scripting application configured to utilize the smart device interface to execute scripting settings to automate the remote smart device features, a user interface of the scripting application configured to facilitate editing of scripting settings when driver workload, as determined by the VCS, is below a predetermined threshold value.

In a second illustrative embodiment, a system includes a processor of a vehicle configured to enable use of an in-vehicle user interface of a scripting application according to a measure of driver workload determined by the vehicle, receive, via the user interface, an action to be performed by the vehicle and a trigger specifying a condition upon which the action should be performed by the vehicle, and store a scripting setting including the action and the trigger by the vehicle.

In a third illustrative embodiment, a system includes a configuration server configured to receive, via a user interface provided by the server, an action to be performed by a vehicle and a trigger specifying a condition upon which the action should be performed by the vehicle, generate a scripting setting including the action and the trigger, and provide the scripting setting over a network to the vehicle for execution.

### BRIEF DESCRIPTION OF THE DRAWINGS

FIG. 1 is an exemplary block topology of a vehicle infotainment system implementing a user-interactive vehicle based computing system;

FIG. 2 illustrates an exemplary smart device integration system;

FIG. 3 illustrates an exemplary user interface of the vehicle infotainment system from which applications may be selected;

FIG. 4 illustrates an exemplary main user interface of the smart device application;

FIG. 5 illustrates an exemplary temperature control user interface of the smart device application;

FIG. 6 illustrates an exemplary door control user interface of the smart device application;

FIG. 7 illustrates an exemplary user interface of the device scripting application for setting a trigger condition for a scripting setting;

FIG. 8 illustrates an exemplary user interface of the device scripting application for setting an action to be triggered for a scripting setting;

FIG. 9 illustrates an exemplary process for the configuration of scripting settings by the vehicle; and

FIG. 10 illustrates an exemplary process for the execution of scripting settings by the vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Many integrations with smart devices include a single application communicating with a single smart device or family of devices, where the single application is configured to allow the user to control the smart device or family of devices via a user interface of the application. While such an approach works with select smart devices, it may be difficult to scale as the number and type of smart devices grows. In the vehicle environment in particular, control of smart devices may lead to distracted driving.

An improved vehicle system may be configured to include features for controlling smart devices without distracting the driver. The system may include a smart device interface configured to communicate with and control the smart devices of the system. The functionality exposed by the smart device interface may then be made available to the other applications of the vehicle system through an application programming interface (API), such that other applications of the vehicle may be able to interact with smart device features. In an example, the API may be registered with a vehicle service configured to define locations and access to the smart devices of the system as well as associated supported functions. If an application of the vehicle would like to control the smart device, the desiring application may request to do so using the exposed smart device interface API. The smart device interface may accordingly act as a broker to translate and perform the request of the calling application, including informing the requester of errors or responses from the controlled smart device.

Once a smart device is configured for use by vehicle system, the system may be further configured to utilize a device scripting application to define scripting settings. The settings may include scripting triggers having conditions based on vehicle data, and scripting actions to be requested by the device scripting application, when the condition is satisfied, to control the smart devices via the smart device interface. For instance, the device scripting application of the system may utilize vehicle data such as location or other information obtained from a connected mobile device (over Bluetooth, WiFi, etc.) as a trigger to control (or notify) the connected smart device to automatically perform an action, without requiring the attention of the driver.

As a more specific example, a vehicle may maintain smart device credentials allowing the smart device interface to be able to connect to a smart home thermostat at the user's home. When the device scripting application of the vehicle determines that the vehicle is heading home and is approximately 30 minutes away, the device scripting application may utilize the smart device interface to trigger the smart thermostat to heat or cool the house to the desired temperature. The system may further include a user interface facilitating the addition of this and other scenarios, without requiring the user to install different applications for each automation purpose.

Thus, the vehicle applications and device scripting application may have access to control the smart devices, resulting in less work for each application, and more overall functionality for the vehicle. Moreover the system may be able to manage when and how to control each smart device, as well as provide appropriate feedback to a calling application when a smart device is unavailable or an error occurs. Thus, by way of the automation, the vehicle may be able to perform tasks for the driver that are secondary to the primary driving task, but related to the control of smart devices.

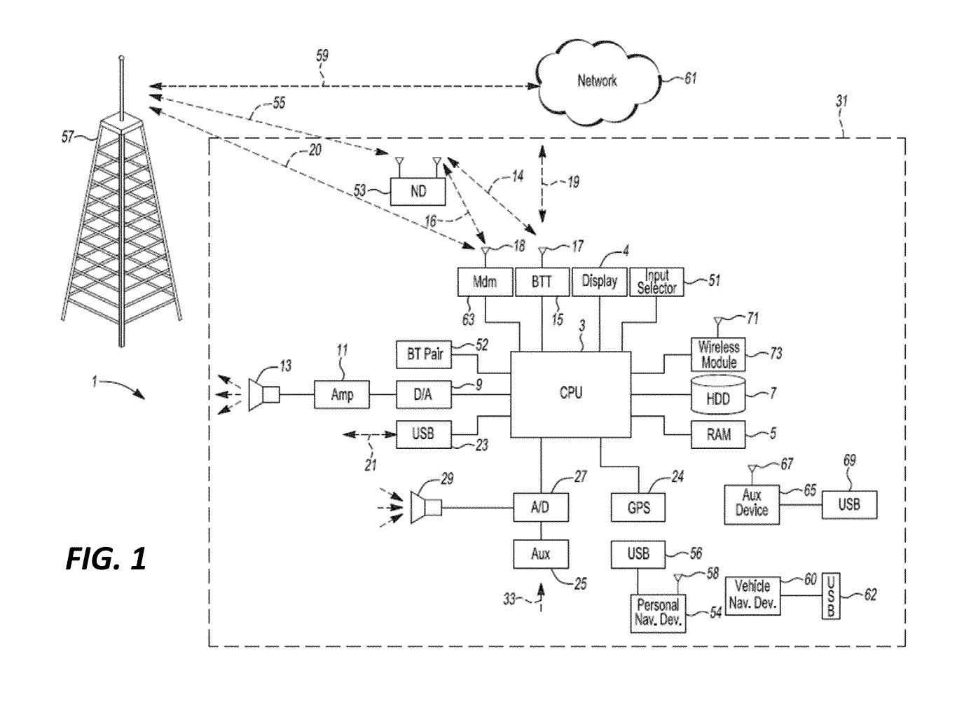

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

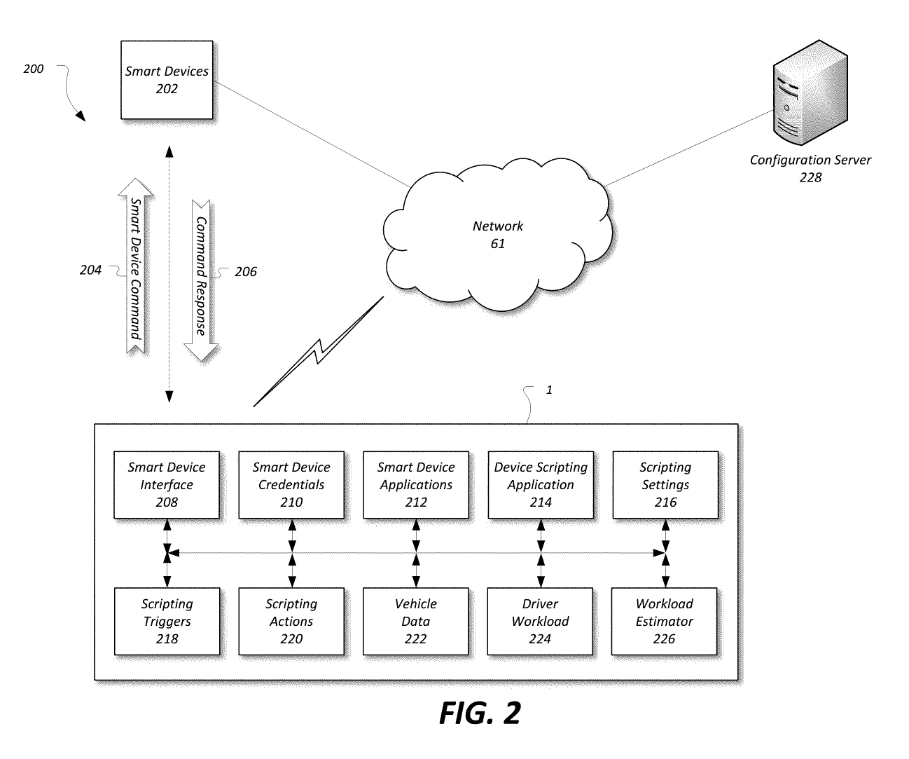

FIG. 2 illustrates an exemplary smart device integration system 200. As illustrated, the system 200 includes smart devices 202 connected to the network 61. The system 200 further includes a smart device interface 208 of the VCS 1 configured to access the smart device 202 according to security credentials 210, send smart devices commands 204 over the network 61 to the smart device 202, and receive command responses 206 over the network 61 from the smart device 202. The system 200 also includes smart devices applications 212 configured to utilize the smart device interface 208 to control the smart devices 202 according to user input, and a device scripting application 214 configured to utilize the smart device interface 208 to control the smart devices 202 according to scripting settings 216. Each scripting setting 216 may be associated with one or more scripting triggers 218 and one or more scripting actions 220. The system further includes a workload estimator 226 configured to receive vehicle data 222 and determine driver workload 224. The system 200 may also include a configuration server 228 configured to facilitate configuration of the scripting settings 216 remote from the vehicle 31. It should be noted that the illustrated system 200 is merely exemplary, and more, fewer, and/or differently located elements may be used. As one example, the system 200 may utilize a data connection of a nomadic device 53 (not shown) to facilitate the communication between the VCS 1 and the smart devices 202.

The smart devices 202 may include various types of network-connected devices that perform useful functions and expose device functionality over the network 61. Exemplary smart devices 202 may include, as some non-limiting examples, networked thermostat controls such as the Nest smart thermostat system provided by Google, Inc. of Mountain View, Calif., and remote door locks such as the Schlage Z-Wave Deadbolt system provided by Allegion Plc of Carmel, Ind. As some further examples, smart devices 202 may include other types of devices such as remote light systems, security devices such as window sensors, flood sensors, webcams, and even media systems such as remote control devices for music playback.

The smart device commands 204 may include messages configured to control functions of the smart devices 202. As illustrated, the smart devices 202 may be configured to receive the smart device commands 204 over the network 61. As some other examples, the smart devices 202 may be configured to receive the smart device commands 204 over other networks or types of network connection, such as over a BLUETOOTH connection, over a ZIGBEE wireless mesh network, or over another suitable type of network or network protocol for providing smart device commands 204. The smart device commands 204 may be configured to cause the smart devices 202 to perform actions, such as lock or unlock doors, set thermostat settings, turn on and off lights, and enable or disable alarm functionality. The command responses 206 may include messages configured to inform senders of the smart device commands 204 whether the smart device commands 204 were successful. In some cases, the smart device commands 204 may be configured to request status information regarding the smart devices 202 (e.g., whether a light is on, whether a door is closed or locked, a current temperature of a home), and the command responses 206 may be configured to return the requested status information back to the requester.

The smart device interface 208 may be configured to provide the VCS 1 with access to the features of the smart devices 202. To provide the access, the smart device interface 208 may be configured to expose an API allowing other applications of the VCS 1 to provide smart device commands 204 to the smart device 202 and receive command responses 206 from the smart device 202 responsive to the provided smart device commands 204.

The smart devices 202 may be configured to require security credentials 210 to allow a device to provide smart device commands 204 to the smart devices 202. As some examples, the smart devices 202 may require an account name or username, and a password, passphrase, personal identification number, fingerprint, or other credential that may be used by the smart devices 202 to ensure that the requesting device is authorized to access the smart device 202 features for the corresponding account or user. The VCS 1 may be configured to maintain and provide the security credentials 210 for the smart devices 202 to facilitate the connection and command execution using the smart device interface 208. In some cases, the smart device interface 208 maybe further configured to maintain information regarding the possible smart devices 202 that may be controllable by the smart device interface 208. For example, the smart device interface 208 may expose in an API information related to the smart devices 202 for which security credentials 210 are available, as well as information regarding the capabilities of the connected smart devices 202 (e.g., based on the model of smart device 202, based on a query of the smart device 202 by the smart device interface 208 for capability information).

The smart device applications 212 may include one or more applications installed to the VCS 1 and configured to make use of functionality of the smart device 202 via the smart device interface 208. As an examples, the smart device applications 212 may include a thermostat smart device application 212 configured to allow a user to view and set home temperature and thermostat settings of a thermostat smart device 202. As another example, the smart device applications 212 may include a security smart device application 212 configured to allow the user to view current door lock status, and lock or unlock service-controlled doors and locks.

The device scripting application 214 may be another example of a smart device application 212, and may be configured to allow a user to script the functions of the smart devices 202. The device scripting application 214 may include functionality to determine when specified trigger conditions 218 have occurred, and to perform specified actions 220 in response to triggering of the trigger conditions 218. These triggers and actions may be referred to herein as scripting settings 216.

The vehicle data 222 may include various inputs that may be monitored by the VCS 1 to receive indications of the vehicle 31 status. Exemplary vehicle data 222 may include, for example, speed, yaw, pitch, roll, lateral acceleration, temperature, and rain sensor inputs, as some possibilities. In some cases, the vehicle data 222 may include elements of data made available via a vehicle bus (e.g., via the controller area network (CAN)). In other cases, the vehicle data 222 may include elements of data that may be otherwise received from vehicle 31 sensors and systems (e.g., yaw information received from a stability system, rain sense information received from a weather detection system, etc., location information received from a positioning system, etc.). It yet further cases, the vehicle data 222 may include other information obtained from a connected mobile device (e.g., from nomadic device 53 over Bluetooth, WiFi, etc.).

The trigger conditions 218 of the scripting settings 216 may be defined according to a relationship of one or more elements of vehicle data 222 to one or more predefined conditions. For example, a trigger condition 218 may be configured to define a relationship of vehicle location to a predefined condition, such as to define a condition that is triggered when the vehicle 31 is heading toward a specified location (e.g., a home location) and is within a threshold distance of that location, (e.g., approximately 30 minutes away according to expected traffic speed, approximately 2 miles away, etc.).

The actions 220 of the scripting settings 216 may be defined according to an available feature of a connected smart device 202. As an example, an action 220 may include sending a smart device command 204 to a thermostat smart device 202 to heat or cool the user's house to a desired temperature. As another example, the action 220 may include sending a smart device command 204 to a security system to unlock a door, or sending a smart device command 204 to a lighting smart device 202 to turn lights on or off.

The device scripting application 214 may further include a user interface facilitating the configuration of the scripting settings 216, without requiring the user to install dedicated smart device application 212 for each purpose. Further aspects of the user interface of the device scripting application 214 are discussed in detail below.

In some cases, the user interface of the device scripting application 214 may be made available to the user only when driver workload 224 permits the user to invoke the user interface. For example, the workload estimator 226 may be configured to receive the vehicle data 222 (e.g., via the CAN bus, from the vehicle systems or sensors, etc.) and identify a driver workload 224 based on the received vehicle data 222. In one possible approach, the workload estimator 226 may be configured to utilize a set of rules to determine a driving situation from the vehicle data 222, and to further determine the driver workload 224 according to the driving situation. More specifically, based on the received vehicle data 222, the workload estimator 226 may be configured to match the received vehicle data 222 against one or more conditions specified by the rules where each rule may be defined to indicate a particular driving situation indication encountered by the vehicle 31 when the conditions of the rule are satisfied. As some examples, rules may define a high traffic density condition according to criteria identifying many stops and starts in brake, accelerator or speed vehicle data 222, a merge condition according to vehicle data 222 indicative of a swerve maneuver at speed, a parked condition according to a park vehicle gear selection indicated in the vehicle data 222, etc.), Moreover, each driving situation may be associated with a corresponding driver workload 224 (e.g., parked vehicle situations associated with a low-level driver workload 224, merge situations associated with a mid-level driver workload 224, high traffic density associated with a high-level driver workload 224). As another example, the workload estimator 226 may associate certain conditions such as extreme weather with heightened driving demand, such that, as one possibility, the workload estimator 226 may associate certain weather conditions combined with a mid-level demand area (e.g., a merge situation) with a heightened workload estimation, such as a high-level driver workload 224. The driver workload 224 may include information indicating a relative level of current driver workload, such as by a value along a scale (e.g., from 1 to 5, from 0.01 to 1.00, etc.).

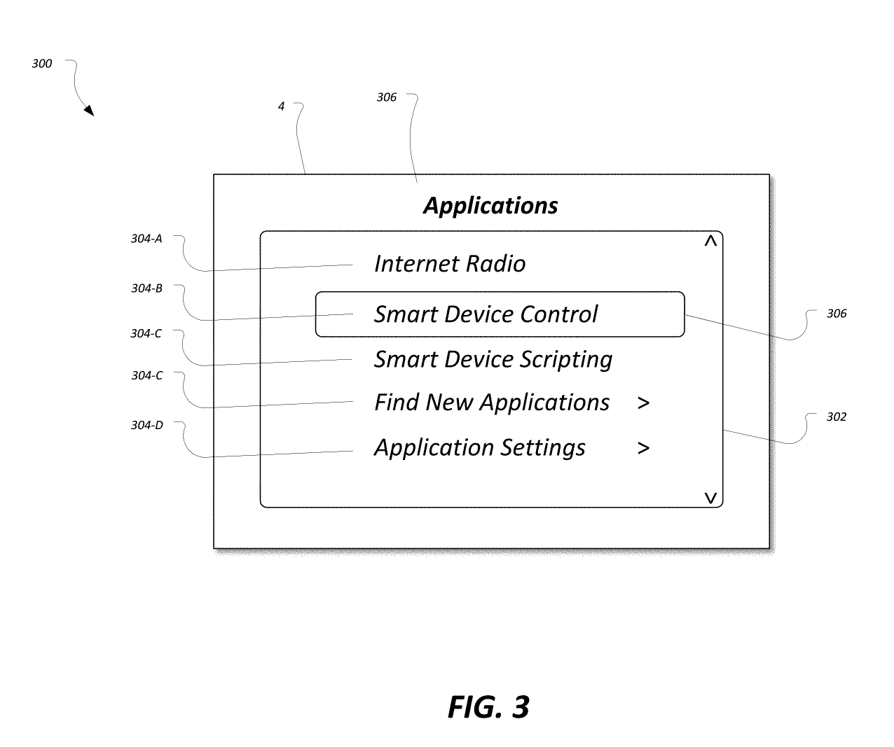

The configuration server 228 may be a server device configured to facilitate configuration of the scripting settings 216 through a user interface that is available outside of the vehicle 31 and regardless of driver workload 224. In an example, the configuration server 228 may be configured to provide a web-based front end user interface (e.g., one or more web pages) or data for use by a thick-client user interface, allowing for the selection of scripting settings 216, such as trigger conditions and actions to be performed by the vehicle 31 resulting from occurrence of the trigger conditions. To perform the configuration, the configuration server 228 may be configured to receive the scripting settings 216 from the vehicle 31, provide a user interface through which the scripting settings 216 may be updated, and provide the updated scripting settings back to the vehicle 31 for use by the device scripting application 214. Further details of the integration of the smart devices 202 into the vehicle 31 system are discussed in detail below with respect to FIGS. 3-10.

FIG. 3 illustrates an exemplary user interface 300 of the VCS 1 from which applications may be selected. The user interface 300 may be presented in the vehicle 31 via the display 4, and may include a list control 302 configured to display selectable list entries 304-A through 304-E (collectively 304) of the application that are available on the VCS 1 (or via a connected nomadic device 53). (In other examples, the user interface 300 and the other user interfaces discussed herein may be displayed elsewhere, such as by way of a connected application executed by a nomadic device 53 paired with the VCS 1.) The user interface 300 may also include a title label 306 to indicate to the user that the user interface 300 is for utilizing the connected applications of the nomadic device 53.

As illustrated, the selectable list 302 of the connected application includes an entry 304-A for an Internet radio application, an entry 304-B for a smart device application 212 and an entry 304-C for the device scripting application 214. The list control 302 may operate as a menu, such that a user of the user interface 300 may be able to scroll through list entries of the list control 302 (e.g., using up and down arrow buttons and a select button to invoke the selected menu item 308). In some cases, the list control 302 may be displayed on a touch screen display 4, such that the user may be able to touch the list control 302 to select and invoke a menu item. For example, when the entry 304-C for the device scripting application 214 is selected, the VCS 1 may initiate the device scripting application 214.

The list control 302 may further include additional entries. For example, the “Find New Applications” entry 304-D, when invoked, may be configured to cause the VCS 1 to query for an updated listing of the applications available to the system (e.g., on the VCS 1, via installed on a connected nomadic device 53, etc.). As another example, the “Application Settings” entry 304-E, when invoked, may be configured to cause the VCS 1 to display a user interface of settings for the application functionality generally.

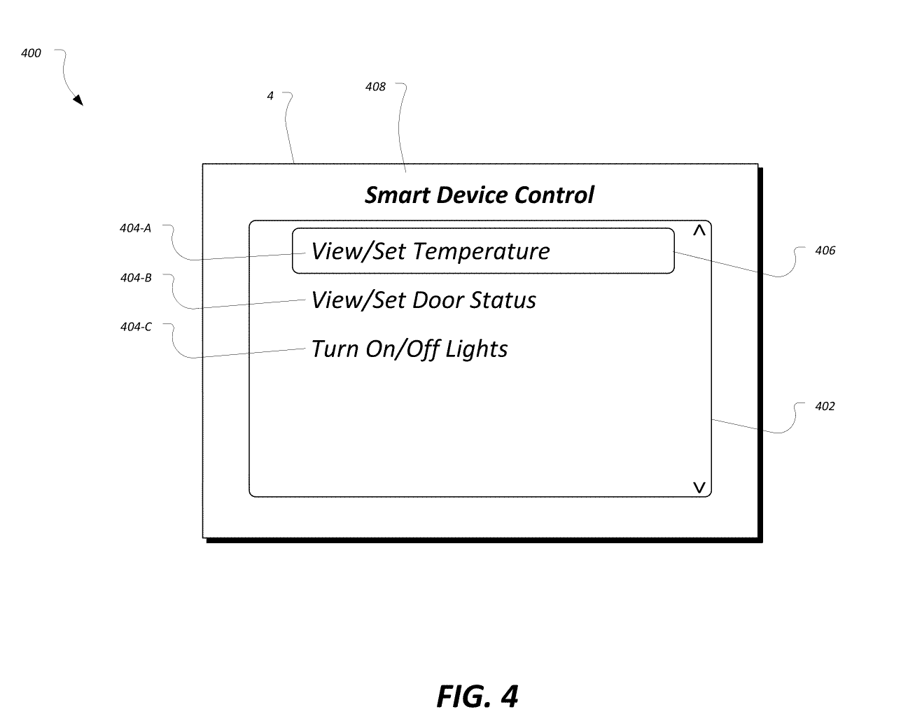

FIG. 4 illustrates an exemplary main user interface 400 of the smart device application 212. As with the user interface 300, the user interface 400 may also be presented in the vehicle 31 via the display 4. The user interface 400 and may include a list control 402 configured to display a selectable list of entries, where each entry is associated with a corresponding application command 404-A through 404-C (collectively 404). Each of the commands 404 may indicate a feature available for use by the VCS 1 in communication with the smart devices 202 via the smart device interface 208. The user interface 400 may also include a title label 408 to indicate to the user that the user interface 400 is for the smart device application 212 (e.g., as invoked via selection of the entry 304-B from the user interface 300).

With respect to the commands 404 of the list control 402, as one example, the list control 402 may include a command 404-A that, when invoked, is configured to cause the VCS 1 to display a user interface including current and target temperature information. As another example, the list control 402 may include a command 404-B that, when invoked, is configured to cause the VCS 1 to display a user interface facilitating the viewing and setting of door status. As a further example, the list control 402 may include a command 404-C that, when invoked, is configured to cause the VCS 1 to display a user interface facilitating the turning on or off of automated lights.

As with the list control 302, the list control 402 may also operate as a menu, such that a user of the user interface 400 may be able to scroll through list entries of the list control 402 (e.g., using up and down arrow buttons and a select button to invoke the selected menu item 406). Upon touch or button selection of one of the commands 404, the VCS 1 may be configured to perform the selected action.

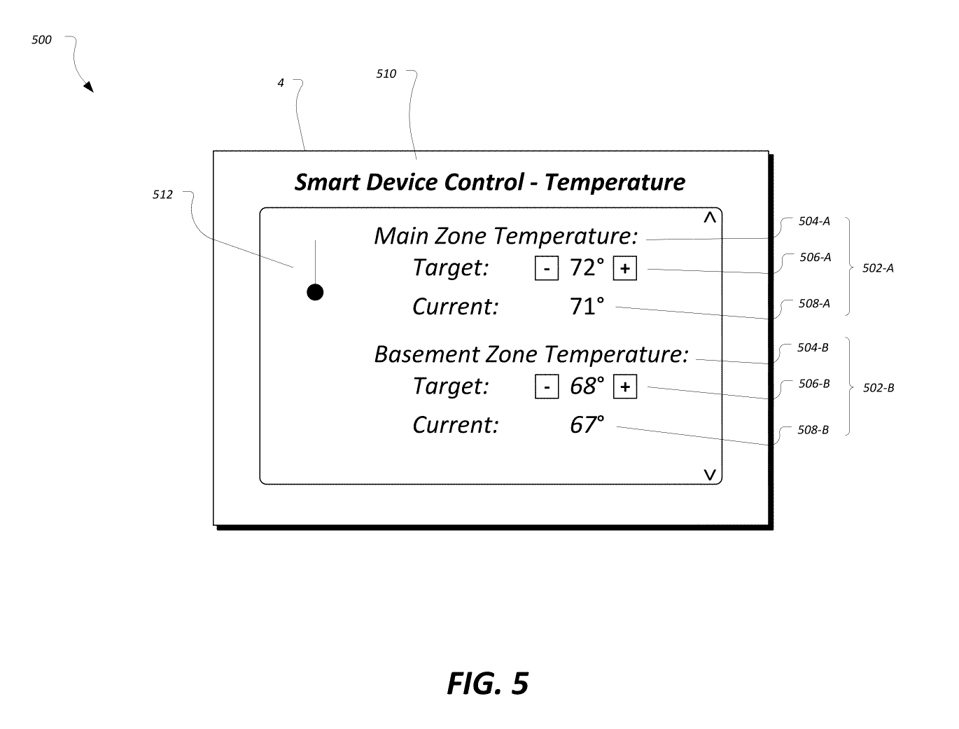

FIG. 5 illustrates an exemplary temperature control user interface 500 of the smart device application 212. As with the user interfaces 300 and 400, the user interface 500 may also be presented in the vehicle 31 via the display 4. As illustrated, the user interface 500 may include temperature information for a first zone 502-A and for a second zone 502-B (collectively 502). For each zone 502, the user interface 500 may further includes an indication identifying the particular zone 504 to the user, a target temperature control 506, and an indication of the current temperature 508. The user interface 500 may also include a title label 510 to indicate to the user that the user interface 500 is for the current and target temperature information screen of the smart device application 212 (e.g., as invoked via the user interface 400), as well as an icon 612 (e.g., a thermometer) or other graphics indicative of temperature.

With respect to the first zone 502-A, the indication of the zone 504-A may indicate the location of the zone 502-A (e.g., the main zone of the home). The temperature control 506-A may be configured to allow the user to set the target temperature for the zone 502-A. To do so, the temperature control 506-A may include an indication of the target temperature, as well as elements to facilitate adjustment of the target temperature. For instance, the elements may include a button that when pressed decreases the target temperature, and a button that when pressed increases the target temperature. The indication of the current temperature 508-A may specify the current temperature of the first zone 502-A.

With respect to the second zone 502-B, the indication of the zone 504-B may similarly indicate the location of the zone 502-B (e.g., the basement zone of the home), the temperature control 506-B may allow the user to view and set the target temperature for the zone 502-B, and the indication of the current temperature 508-B may specify the current temperature of the zone 502-B. (It should be noted that the specific capabilities and definitions of the zones to be displayed may be received from the smart device interface 208 by the smart device application 212.)

When the user requests to increase or decrease the target temperature via the temperature control 506 of the smart device application 212, the smart device application 212 may be configured to provide smart device commands 204 to the smart device 202 responsible for temperature control via the smart device interface 208. For example, if the user wishes to increase the target temperature for the first zone 602-A from 72° to 73°, the user may press the temperature increase button of the temperature control 606-A. Responsive to the request, the smart device application 212 may request for the smart device interface 208 to provide a smart device command 204 requesting, for example, to set the target temperature for the zone 602-A to 73°. The temperature smart device 202 may receive the smart device command 204, and may adjust the target zone temperature. Accordingly, by way of the temperature control user interface 500, a user may be able to adjust temperature settings of the temperature smart device 202 using the in-vehicle user interface.

Similarly, the VCS 1 may be configured to provide smart device commands 204 to the temperature smart device 202 via the smart device interface 208 to allow the smart device application 212 to request the current temperature information to provide in the indication of the current temperature 508-A as well as the target temperature information to provide in the temperature control 506-A. The temperature smart device 202 receiving the smart device commands 204 may, for example, retrieve the information from the home thermostat, and return the requested information to the smart device interface 208 in command responses 206, to be provided to the smart device application 212 for display.

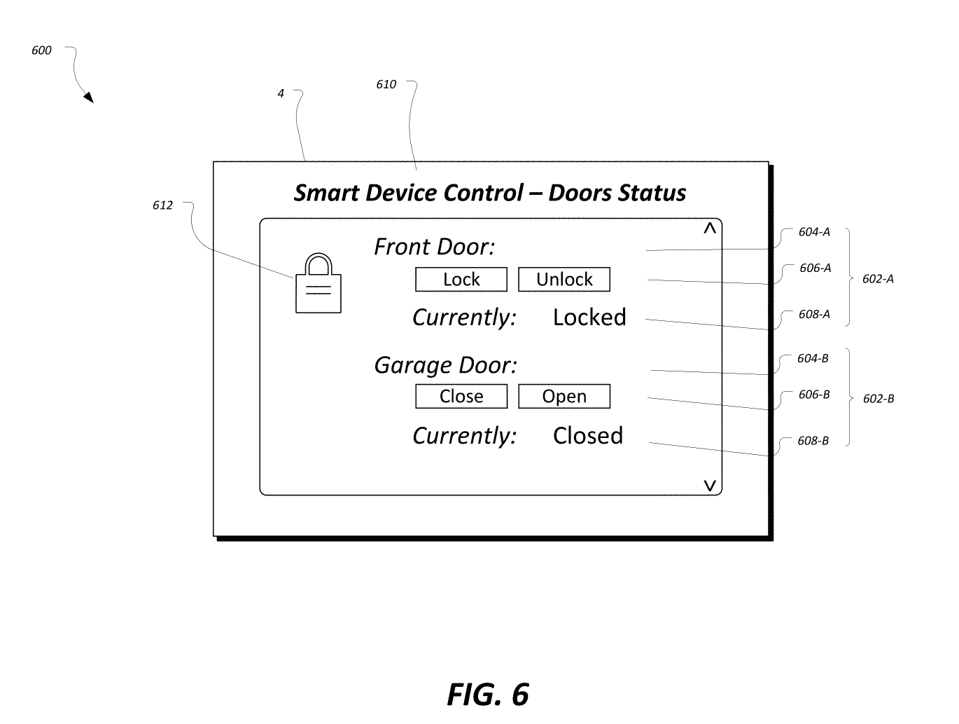

FIG. 6 illustrates an exemplary door control user interface 600 of the smart device application 212. As with the user interfaces 300-500, the user interface 600 may also be presented in the vehicle 31 via the display 4. As illustrated, the user interface 600 may include door information for a first door 602-A and for a second door 602-B (collectively 602). For each door 602, the user interface 600 may further includes a door indication 604 identifying the particular door 602 to the user, door state adjustment controls 606, and an indication of the current door state 608. The user interface 600 may also include a title label 610 to indicate to the user that the user interface 600 is for the door information screen of the smart device application 212 (e.g., as invoked via the user interface 400), as well as an icon 612 (e.g., a lock) or other graphics indicative of door status.

With respect to the first door 602-A, the indication of the zone 604-A may indicate that the information relates to the front door. The door state adjustment controls 606-A may be configured to include elements allowing the user to set the lock and unlock status of the door 602-A. For instance, the elements may include a button that when pressed causes the door to unlock, and a button that when pressed causes the door to lock. The indication of the current door state 608 may accordingly specify whether the door reports as being locked or unlocked.

With respect to the second door 602-B, the indication of the zone 604-B may indicate that the door 602-A is the garage door. The door state adjustment controls 606-B may be configured to include elements allowing the user to open and close the garage door 602-B For instance, the elements may include a button that when pressed causes the door to open, and a button that when pressed causes the door to close. The indication of the current door state 608 may accordingly specify whether the door reports as being opened or closed. (It should be noted that the specific capabilities and definitions of the doors to be displayed may be received from the smart device interface 208 by the smart device application 212.)

To perform the door lock/unlock and open/close commands, the smart device application 212 may be configured to provide smart device commands 204 to the smart devices 202 via the smart device interface 208. For example, if the user wishes to lock the front door 602-A, user may press the lock button of door state adjustment controls 706-A. Responsive to the request, the smart device application 212 may request for the smart device interface 208 to provide a smart device command 204 requesting that the door 702-A be locked. In turn, the smart device interface 208 may send a smart device command 204 to the security smart device 202 to which the smart device interface 208 is logged into (e.g., using the security credentials 210) requesting that the door 602-A be locked. The smart device 202 receiving the smart device command 204 may, in turn, send a request to the home door lock to lock the door 602-A. Accordingly, by way of the door status user interface 600, a user may be able to adjust door lock and closure settings of the home using the in-vehicle user interface.

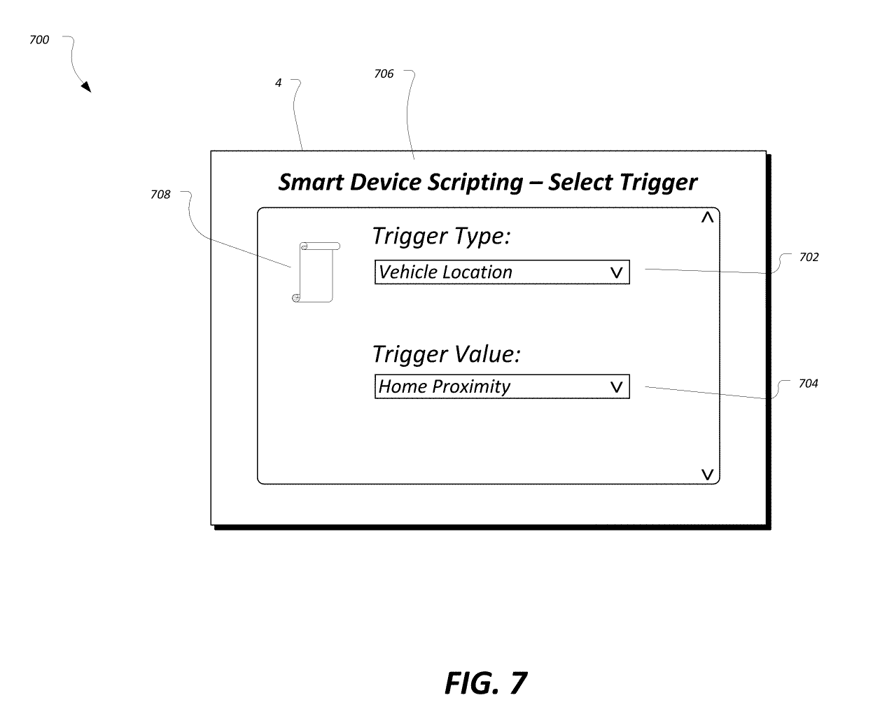

FIG. 7 illustrates an exemplary user interface 700 of the device scripting application 214 for setting a scripting trigger 218 for a scripting setting 216. As with the user interfaces 300-600, the user interface 700 may also be presented in the vehicle 31 via the display 4. The user interface 700 may include a trigger type control 702 configured to display a selectable list of possible actions that may be utilized as scripting triggers 218 for a scripting setting 216, where each entry is associated with a corresponding scripting trigger 218. The user interface 700 may also include a trigger value control 704 configured to display a selectable list of possible trigger values of the selected trigger type that may be utilized to complete the definition of the scripting trigger 218 for the scripting setting 216. The user interface 700 may also include a title label 706 to indicate to the user that the user interface 700 is for the trigger selection portion of editing a scripting setting 216 by the (e.g., as invoked via selection of the entry 304-C from the user interface 300), as well as an icon 708 (e.g., a script) or other graphics indicative of scripting functionality.

As illustrated, the exemplary trigger type is that of vehicle location, and the exemplary trigger value is home proximity. However, the trigger type may be that of any other type of condition available for evaluation by the device scripting application 214 according to the vehicle data 222. As some other non-limiting examples, the trigger type may be that of vehicle speed, transmission temperature, time of day, day of week, and weather condition, as some possibilities. Moreover, the trigger value may be any user-input value that may be of a type comparable by the device scripting application 214 with the data of the trigger type. The trigger values may accordingly be values such as day, time, a number representative of a temperature, a value from an enumeration of possibilities (e.g., rain, sun, and snow for an enumeration of possible weather types), and a predefined value (e.g., a geographic location stored by the VCS 1 such as home or work). In some cases, scripting triggers 218 may include the combination of multiple trigger types and trigger values. For example, the scripting trigger 218 may include both a location condition and a time of day condition that both must be met to cause the trigger condition to be satisfied.

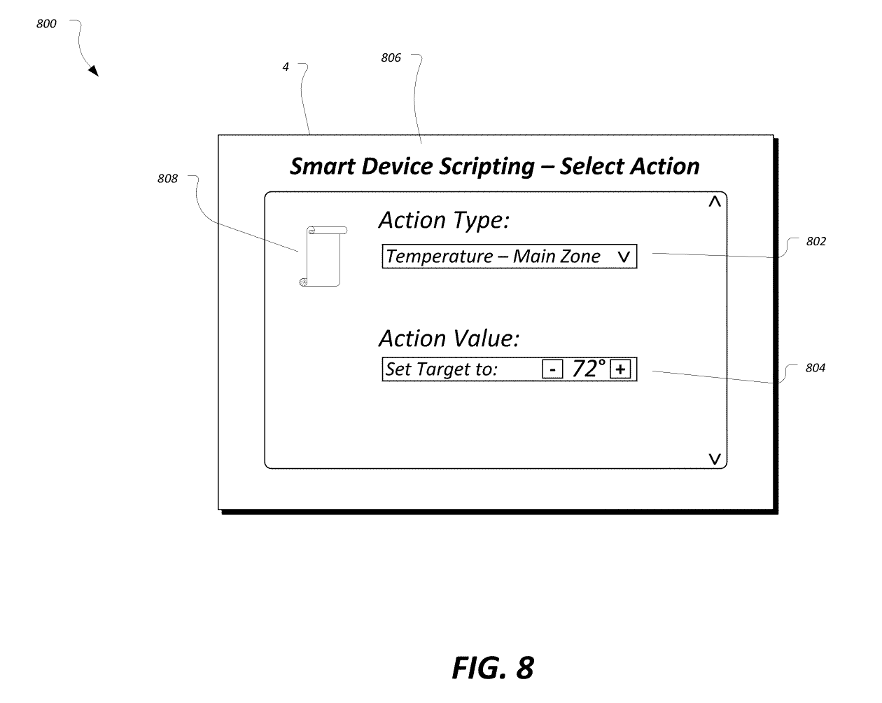

FIG. 8 illustrates an exemplary user interface 800 of the device scripting application 214 for setting a scripting action 220 for a scripting setting 216. As with the user interfaces 300-700, the user interface 800 may also be presented in the vehicle 31 via the display 4. The user interface 800 may include an action type control 802 configured to display a selectable list of possible scripting actions 220 that may be performed upon satisfaction of the scripting trigger 218 of the scripting setting 216 (e.g., as defined using the user interface 700). The user interface 800 may also include an action value control 804 configured to display a selectable list of possible action values of the selected action type that may be utilized to complete the definition of the scripting action 220 for the scripting setting 216. The user interface 700 may also include a title label 706 to indicate to the user that the user interface 700 is for the action selection portion of editing a scripting setting 216 by the smart device application 212 (e.g., as invoked via selection of the entry 304-C from the user interface 300), as well as an icon 708 (e.g., a script) or other graphics indicative of scripting functionality.

As illustrated, the exemplary action is to command the main zone temperature, and the action value is to set that temperature to 72° Fahrenheit. However, the action type may be that of any other type of action available for performance by the smart devices 202 under the command of the smart device interface 208, and the action value may be any value that may be set to the smart devices 202. (The specific listing of action types and action values that are available for automation may be requested by the device scripting application 214 using the smart device interface 208.) As some other non-limiting examples, the action type and action value may be a door setting similar to as illustrated in the user interface 600, a light setting, or some other functionality of a smart device 202 accessible to the vehicle 31 via the smart device interface 208.

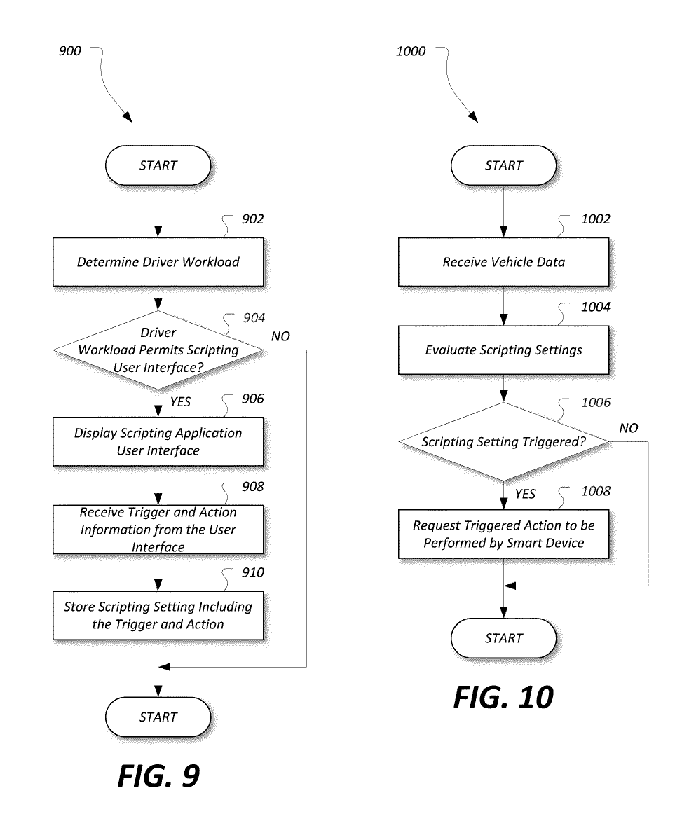

FIG. 9 illustrates an exemplary process 900 for the configuration of scripting settings 216 by the vehicle 31. The process 900 may be performed by the VCS 1, for example, responsive to a user request to edit the scripting setting 216 of the vehicle 31.

At operation 902, the VCS 1 identifies the driver workload 224. For example, the workload estimator 226 may receive vehicle data 222 via a vehicle bus or from vehicle 31 sensors and systems, and may identify a driver workload 224 based on the received vehicle data 222. In one possible approach, the workload estimator 226 may be configured to utilize a set of rules to determine a driving situation from the vehicle data 222, and to further determine the driver workload 224 according to the driving situation.

At operation 904, the VCS 1 determines whether the driver workload 224 permits use of the user interface of the device scripting application 214. For example, if the VCS 1 determines that the driver workload 224 is low (e.g., when the vehicle 31 is parked), then the VCS 1 may allow use of the user interface of the device scripting application 214 and may pass control to operation 906. Otherwise, the VCS 1 may determine that use of the user interface of the device scripting application 214 is currently inadvisable, and the process 900 ends.

At operation 906, the VCS 1 displays the user interface of the device scripting application 214 in the vehicle 31. As some examples, the VCS 1 may display one or more of the user interface 700 and the user interface 800 on the display 4 of the vehicle 31.

At operation 908, the VCS 1 receives scripting trigger 218 and scripting action 220 information. For example, the VCS 1 may receive the scripting trigger 218 information from the user interface 700 and may receive the scripting action 220 information from the user interface 800. In some cases, the scripting trigger 218 and scripting action 220 information may be information for a new scripting settings 216 to be created, while in other cases, the scripting trigger 218 and scripting action 220 information may be for an existing scripting setting 216 that is being edited.

At operation 910, the VCS 1 stores a scripting setting 216 including the scripting trigger 218 and scripting action 220 information. For example, the VCS 1 may be configured to store the scripting setting 216 within the persistent storage 7 of the VCS 1. Additionally or alternately, the VCS 1 may be configured to provide the scripting settings 216 to the configuration server 228 for storage. After operation 910, the process 900 ends. In other examples, the process may return to operation 906 to allow the user to continue editing of the scripting triggers 218 for the vehicle 31.

Variations on the process 900 are possible. As an example, the user interface 700 and the user interface 800 may be provided by the configuration server 228 rather than being displayed by the VCS 1. In such an example, the operations 902 and 904 may not be required. However, the configuration server 228 may be configured perform operations including to provide updated scripting settings 216 to the VCS 1 for use by the vehicle 31, e.g., in the operation 910.

FIG. 10 illustrates an exemplary process 1000 for the execution of scripting settings 216 by the vehicle 31. The process 1000 may be performed, for example, by the VCS 1 of the vehicle 31 according to the scripting settings 216 of the vehicle 31. In some cases, the process 1000 may be performed periodically, e.g., every second, every 60 seconds, while in other cases, the process 1000 may be performed at scheduled times, such as on the hour, or as manually requested or otherwise specified by a user.

At operation 1002, the VCS 1 receives vehicle data 222. For example, the device scripting application 214 may receive vehicle data 222 via a vehicle bus, from vehicle 31 sensors and systems, and/or from any connected mobile devices.

At operation 1004, the VCS 1 evaluates the scripting triggers 218 of the scripting settings 216. For example, the device scripting application 214 may use the received vehicle data 222 to evaluate the scripting triggers 218 of the scripting settings 216 maintained by the VCS 1 of the vehicle 31.

At operation 1006, the VCS 1 determines whether any of the scripting settings 216 are triggered. For example, the device scripting application 214 may determine which, if any, of the scripting triggers 218 evaluate to trigger values that trigger the corresponding conditions. If so, control passes to operation 1008. Otherwise the process 1000 ends.

At operation 1008, the VCS 1 requests any triggered scripting actions 220 to be performed by the smart devices 202. For example, the device scripting application 214 may be configured to utilize the smart device interface 208 to request for the VCS 1 to provide smart device commands 204 to the smart devices 202 configured to carry out the scripting actions 220 that correspond to any scripting settings 216 having triggered conditions. The details of the smart device commands 204 may be as specified by the action types and action values of the triggered scripting settings 216. After operation 1008, the process 1000 ends.

Thus, by way of described automation system, the vehicle 31 may be able to perform tasks for the driver that are secondary to the primary driving task, but related to the control of smart devices 202. As an example, when the device scripting application 214 determines that the vehicle 31 is heading home and is approximately 30 minutes away, the device scripting application 214 may utilize the smart device interface 208 to send a command over the network 61 to a thermostat smart device 202 to cause the thermostat to heat or cool the house to the desired temperature. As another example, once arriving within radius of a BLUETOOTH security device, such as a Locitron remote door locking smart device 202 provided by Apigy Inc. of Mountain View, Calif., the vehicle may trigger a condition causing the VCS 1 to command the smart device 202 to unlock the door over BLUETOOTH. As yet another example, when the vehicle 31 parts within a predetermined distance to a connected parking meter smart device 202, the VCS 1 may be configured to invoke a parking payment smart devices application 212 facilitating communication with the parking meter via the Zigbee protocol.

In general, computing systems and/or devices, such as the VCS 1, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices such as the VCS 1 and nomadic devices 53 generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Objective C, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a vehicle computing system (VCS) including
a smart device interface configured to provide VCS applications with access to remote smart device features,
a scripting application configured to utilize the smart device interface to execute scripting settings to automate the remote smart device features, and
a user interface of the scripting application configured to facilitate editing of scripting settings when driver workload, as determined by the VCS, is below a predetermined threshold value.

2. The system of claim 1, wherein the remote smart device features include at least one of thermostat, security, and lighting features exposed by network-connected smart devices over a network accessible to the smart device interface.

3. The system of claim 1, wherein the VCS further includes a smart device application configured to:
provide a second user interface facilitating direct control of the remote smart device features; and
utilize the smart device interface to control the remote smart device features.

4. The system of claim 3, wherein the smart device application is further configured to display, in the second user interface, current status information regarding the remote smart device features in the user interface obtained using the smart device interface.

5. The system of claim 1, wherein each of the scripting settings includes an action to be performed by the vehicle and a trigger specifying a condition upon which the action should be performed by the vehicle.

6. The system of claim 5, wherein the scripting application is further configured to:
execute the scripting setting according to vehicle information to determine whether the condition of the trigger has occurred, and
perform the action by the vehicle when the condition of the trigger is met.

7. The system of claim 5, wherein the VCS is further configured to send a smart device command to a smart device to cause the smart device to perform the action of the scripting setting.

8. The system of claim 7, wherein the VCS is further configured to receive a command response from the smart device indicative of a result of the action.

9. The system of claim 1, wherein the predetermined threshold value is indicative of the vehicle being parked.

10. A system comprising:
a processor of a vehicle configured to
enable use of an in-vehicle user interface of a scripting application according to a measure of driver workload determined by the vehicle,
receive, via the user interface, an action to be performed by the vehicle and a trigger specifying a condition upon which the action should be performed by the vehicle, and
store a scripting setting including the action and the trigger by the vehicle.

11. The system of claim 10, wherein the processor is further configured to:
execute the scripting setting according to vehicle information to determine whether the condition of the trigger has occurred, and
perform the action by the vehicle when the condition of the trigger is met.

12. The system of claim 10, wherein the processor is further configured to send a smart device command to a remote smart device to cause the remote smart device to perform the action of the scripting setting.

13. The system of claim 12, wherein the processor is further configured to receive a command response from the remote smart device indicative of a result of the action.

14. A system comprising:
a configuration server configured to:
receive, via a user interface provided by the server, an action to be performed by a vehicle and a trigger specifying a condition upon which the action should be performed by the vehicle,
generate a scripting setting including the action and the trigger, and
provide the scripting setting over a network to the vehicle for execution.

15. The system of claim 14, wherein the user interface provided by the server includes a web page.

16. The system of claim 15, wherein the scripting setting is configured to be executed by the vehicle regardless of driver workload, and viewable in the user interface of the vehicle when permitted by the driver workload.

17. The system of claim 14, further comprising:
a vehicle computing system (VCS) of the vehicle including
a smart device interface configured to provide VCS applications with access to remote smart device features; and
a scripting application configured to utilize the smart device interface to execute the scripting setting to automate at least one remote smart device feature.

18. The system of claim 17, wherein the VCS is further configured to send a smart device command to a remote smart device to cause the remote smart device to perform the action of the scripting setting.

19. The system of claim 18, wherein the VCS is further configured to receive a command response from the remote smart device indicative of a result of the action.

20. The system of claim 18, wherein the VCS is further configured to enable use of a user interface of the scripting application according to a measure of driver workload determined by the VCS.
